(19) United States
(12) Patent Application Publication
(10) Pub. No.: US 2024/0269963 A1
(43) Pub. Date: Aug. 15, 2024

(54) QUICK-DRYING SLOPE SCREED

(71) Applicant: SIKA TECHNOLOGY AG, Baar (CH)

(72) Inventors: Nicole UNDERBERG, Dorsten (DE); Nick SCHNEIDER, Billerbeck (DE)

(73) Assignee: SIKA TECHNOLOGY AG, Baar (CH)

(21) Appl. No.: 18/567,256

(22) PCT Filed: Jul. 12, 2022
(86) PCT No.: PCT/EP2022/069392

§ 371 Date: Dec. 5, 2023

(30) Foreign Application Priority Data
Jul. 16, 2021 (EP) 21186140.6

(51) Int. Cl. B32B 13/12; B32B 7/12; B32B 38/00; C04B 7/32; C04B 11/30; C04B 14/28; C04B 24/02; C04B 24/06; C04B 28/06; C04B 28/16

(52) U.S. Cl. CPC B32B 13/12; B32B 7/12; B32B 38/164; C04B 7/323; C04B 11/30; C04B 14/28; C04B 24/02; C04B 24/06; C04B 28/065; C04B 28/16; B32B 2315/06; B32B 2419/04

(57) ABSTRACT

A method for producing a floor construction on a substrate by applying a screed to the substrate and then applying a seal to the screed. The screed is based on a screed composition which includes an aluminate binder, a calcium sulfate binder and fillers, where the amount of filler is 30 to 80 wt % and the total amount of aluminate binder and calcium sulfate binder is 20 to 70 wt % and the weight ratio of aluminate binder to calcium sulfate binder is in the range from 1:1 to 1:5. The method enables a short production time and at the same time improved adhesion between screed and seal.

### TECHNICAL FIELD

The present invention relates to a method for producing a floor construction which contains a seal and to a floor construction of this kind.

### Prior Art

In the flooring sector among others, there is a trend toward using what are known as binary and ternary binders for the formulation of building materials, for example screeds. Binary binders comprise aluminate cement and calcium sulfate as hydraulic binders. Ternary binders additionally comprise Portland cement as a third hydraulic binder. Binary and ternary binders have the particular advantage of a shorter time until they are ready for covering compared to standard cements. This means it is possible within a shorter time to continue working, which is a key economic advantage.

In areas where the floor may come into contact with substantial amounts of water or moisture, though, such as in bathrooms, water or moisture penetration may cause considerable problems. The floor construction may be damaged, by detachment of tiles where they are part of the floor construction, for example, or mold may establish itself. Preventing such damage requires that the floor construction is provided with a seal to protect it from water penetration. Relevant regulations are contained for example in DIN standards 18531 to 18535 or in information sheets published by the German Construction Confederation (ZDB).

Relevant designs are, for example, sheetlike seals, in the form of plastic membranes, for example, applied generally by adhesive bonding, or sealing materials which are applied in fluid or pasty form and solidify to form the seal. Such floor constructions are oftentimes also finished with tiled or slab floorcoverings.

Fast-cure products based on ternary binder systems with screed suitability, particularly for the interior, are available commercially, examples being Schönox® CLS (Sika Schweiz AG), Ardex® K75 (ARDEX Skandinavia NS, Denmark), and Centro GA#50 Speed (Centro Kakel och Klinker AB, Sweden). The curing duration of these products, though, is still in need of improvement.

In floor constructions containing a seal, moreover, the adhesion between the seal and the underlying screed is important for a stable structure. The tensile adhesive strengths obtained with the commonplace systems between seal and screed, however, are often inadequate, especially if the intention is for very early further processing by application of the seal to the applied screed.

WO 2015/150319 A1 relates to fast-drying plaster compositions based on calcium aluminate and calcium sulfate as hydraulic binders, particularly for use as a filling compound for floorcoverings.

WO 2016/142365 A1 relates to a fast-setting chemical construction formulation which comprises a binder based on calcium sulfate, at least one ettringite former, at least one activator, at least one filler and at least one redispersible powder, and to use thereof for producing thin-bed leveling compounds, self-leveling and nonsagging filling compounds, screed binders or screed mortars, adhesive tile mortars, jointing mortars and grouts.

### SUMMARY OF THE INVENTION

It is an object of the present invention to provide a method for producing a floor construction with sealing function, such as a membrane, with which a shorter curing process for the screed and improved tensile adhesive strength are achievable. The intention in particular is to enable sufficiently high tensile adhesive strength between screed and seal even where the seal is applied very quickly after the screed has been laid.

It has been determined that this object may be achieved in particular by using a specific screed composition based on a combination of aluminate binder and calcium sulfate binder as hydraulic binder in particular amounts and proportions.

The invention therefore relates to a method for producing a floor construction on a substrate, comprising the following steps:
a) mixing a screed composition with water to form a screeding compound,
b) applying the screeding compound to the substrate,
c) drying the screeding compound to form a dried screed, and
d) applying a seal to the dried screed by
   d1) adhering a sheetlike or platelike membrane to the dried screed using an adhesive or
   d2) applying a fluid or pasty sealing material to the dried screed, with the sealing material solidifying to form the seal, and
e) optionally applying a floorcovering to the seal,
where the screed composition comprises
i) an aluminate binder selected from calcium aluminate cement and/or calcium sulfoaluminate cement,
II)a calcium sulfate binder selected from calcium sulfate hemihydrate and/or calcium sulfate anhydrite, and
iii) one or more fillers,

where the amount of filler is 30% to 80% by weight and the total amount of aluminate binder and calcium sulfate binder is 20% to 70% by weight, with the weight ratio of aluminate binder to calcium sulfate binder being in the range from 1:1 to 1:5, the weight figures being based on the dry weight of the screed composition.

The most prominent advantage of the method of the invention over the prior art systems lies in improved tensile adhesive strength of the construction (adhesion between screed and seal, e.g., membrane) after a short duration of screed curing. In accordance with the invention, in particular, sufficiently high tensile adhesive strengths are achieved after a screed curing time of just 4 h and 24 h, respectively. The early strength values also increase over time. Prior art systems have only very little or no tensile adhesive strength after a filling compound curing time of only 4 h or 24 h.

This effect of the method of the invention hence makes it possible to reduce waiting time before the next operation (e.g., in the field of prefabricated pool construction). This reduced waiting time saves the user money and allows production capacities to be increased. The method thus allows for a short production time and at the same time improved adhesion between screed and seal.

This and other advantages of the invention may be summarized as follows:
fast drying properties for the screed, more or less independently of the temperature (especially at low temperatures)
significant tensile adhesive strength between screed and seal, more particularly membrane, after short screeding compound curing times
tensile adhesive strengths are more or less independent of screed layer thickness
the duration of drying/curing of the screeding compound is largely independent of the layer thickness. Whether the screed is applied in a layer thickness of 5 mm or 50 mm makes virtually no difference to the drying time, this having the great advantage of enabling high layer thicknesses without substantially prolonging drying times
In terms of the results achieved, the nature of the adhesive for bonding a sheet product (e.g., Schönox® AB) as seal is not very relevant; both dispersion-based adhesives (e.g., Schönox® HA) and powder-based adhesives (e.g., Schönox® iFix) may be used, with powder-based adhesives drying more quickly (Schönox products are from Sika Schweiz AG). Other adhesives, such as tile adhesives, are also suitable.
low CO2 footprint in comparison to conventional ternary-based binder systems

### Ways of Executing the Invention

The method of the invention comprises as step a) the mixing of a screed composition with water to form a screeding compound.

The screed composition is in particular a solid screed composition, in the form of a powder, for example. The screed composition is in particular a dry screed composition.

The screed composition used in the method of the invention comprises
i) an aluminate binder selected from calcium aluminate cement and/or calcium sulfoaluminate cement,
ii) a calcium sulfate binder selected from calcium sulfate hemihydrate and/or calcium sulfate anhydrite, and
iii) one or more fillers.

The aluminate binder is calcium aluminate cement and/or calcium sulfoaluminate cement. The aluminate binder is preferably calcium sulfoaluminate cement. The aluminate binder is a hydraulic binder.

In one embodiment, the aluminate binder comprises at least one calcium aluminate cement (CAC). A calcium aluminate cement (CAC) according to the present invention is in particular a cement comprising a clinker which comprises hydraulic calcium aluminates, the main phase being preferably CA (C: CaO; A: Al₂O₃). Other calcium aluminates, such as C₂A, C₃A, and C₁₂A₇, for example, are typically likewise present. CACs for the present invention may typically also contain other phases, selected from gehlenite (C₂AS with C: CaO, A: Al₂O₃), perovskite (CT with C: CaO, T: TiO₂), belite (C₂S with C: CaO, S: SiO₂), tricalcium silicate, ferrites (C₂F, C₂AF, C₄AF with C: CaO; A: Al₂O₃; F: Fe₂O₃), ternesite (C₅S₂$ with C: CaO, S: SiO₂; $: SO₃) and aluminum oxide. CACs of the present invention may additionally contain calcium carbonate. In particular, a CAC of the present invention preferably conforms to the standard EN 14647. Equally suitable are CACs described in other standards, e.g., ASTM or Chinese standards. Suitable CACs may be obtained commercially for example from Royal White Cement.

In one embodiment, the aluminate binder comprises at least one calcium sulfoaluminate (CSA) cement. A CSA cement according to the present invention is in particular a cement comprising a clinker which comprises C₄(A₃₋ₓFₓ)$ (C: CaO; A: Al₂O₃; F: Fe₂O₃; $: SO₃) where x is an integer of 0−3. CSAs for the present invention may typically contain further phases, selected from aluminates (CA, C₃A, C₁₂A₇, with C: CaO; A: Al₂O₃), belite (C₂S, with C: CaO, S: SiO₂), ferrites (C₂F, C₂AF, C₄AF, with C: CaO; A: Al₂O₃; F: Fe₂O₃), ternesite (C₅S₂$ with C: CaO, S: SiO₂; $: SO₃) and anhydrite. In certain embodiments of the invention, the CSA contains 15-75% by weight C₄A₃$, 0-10% by weight aluminates, 0-70% by weight belite, 0-35% by weight ferrites, 0-20% by weight ternesite, and

0-25% by weight anhydrite, based in each case on the total dry weight of the CSA cement. Any anhydrite present is part of the CSA cement and is to be included therein. Suitable CSAs may be obtained for example under the trade name Calumex from Caltra B.V.

The calcium sulfate binder is a hydraulic binder. The calcium sulfate binder is selected from calcium sulfate hemihydrate (CaSO₄·½ H₂O) and/or calcium sulfate anhydrite (CaSO₄), with calcium sulfate hemihydrate being preferred. Calcium sulfate anhydrite is anhydrous calcium sulfate (no water of crystallization). Calcium sulfate hemihydrate comprises alpha-calcium sulfate hemihydrate and beta-calcium sulfate hemihydrate, with alpha-calcium sulfate hemihydrate being preferred.

In relation to the calcium sulfate binder, it is preferred for it to consist substantially or completely of calcium sulfate hemihydrate, since too high a proportion of anhydrite results in excessively rapid uptake of water by the anhydrite constituent, which may affect the workability of the composition. Accordingly, it is preferred if at least 80% by weight of the total amount of calcium sulfate binder, preferably at least 90% by weight and more preferably at least 95% by weight, is accounted for by the calcium sulfate hemihydrate (balance: calcium sulfate anhydrite).

Calcium sulfate dihydrate (CaSO₄·2 H₂O) is incapable of binding water and so is not included here within the calcium sulfate binder. However, calcium sulfate dihydrate may optionally also be present in the screed composition. Calcium sulfate dihydrate may act as a “nucleating agent” and produces a faster reaction of the calcium sulfate hemihydrate. The screed composition therefore preferably comprises calcium sulfate dihydrate.

The screed composition further comprises one or more fillers, which are also referred to as aggregates. This may be any solid material which is inert for the hydration reaction of the hydraulic binder. Fillers or aggregates used may be the substances known to the person skilled in the art. Examples of fillers or aggregates are rock, crushed stone, gravel, slag, ground rock, recycled rock aggregate, recycled concrete, sand, such as quartz sand or river sand, ground rock, glass, expanded glass, hollow glass beads, glass-ceramic, volcanic rock, pumice stone, perlite, vermiculite, porcelain, electrically fused or sintered abrasives, firing aids, silica xerogels, carbonates, such as ground limestone, ground dolomite and chalk, and/or ground alumina.

It is possible to use solid materials for which opportunities for (re)utilization are being sought. Examples of such fillers or aggregates are:
(i) materials of biological origin, preferably plant origin, especially materials of plant origin consisting substantially of cellulose and/or lignin
(ii) synthetic non-mineral materials, preferably selected from thermoplastics or thermosets, elastomers, rubbers, textile fibers, and plastics materials reinforced with glass or carbon fibers
(iii) inorganic aggregates from the demolition of structural and civil engineering edifices, preferably selected from concrete wastes, mortar, brick, natural stone, asphalt, tiles, shingles, aerated concrete, clinker, and metal scrap
(iv) organic aggregates from the recycling of industrial products, especially difficult-to-recycle composite materials, more particularly recycled insulating materials
(v) granular materials presenting no health concerns and normally intended for landfill, such as used foundry sands, catalyst supports, clinker adjuvants, fillers from the treatment of excavation sludge, sewage sludge, liquid manure, paper wastes, paper combustion ash, household garbage combustion ash.

In one preferred embodiment, the one or more fillers and/or aggregates comprise sand and/or carbonatic fillers, preferably in the form of calcium carbonate. Suitable sands are described for example in the standards ASTM C778 or EN 196-1. Calcium carbonate also embraces limestone and chalk. The sand may in particular be quartz sand or river sand.

A suitable quartz sand has a grading curve for example within a range from about 0 to 0.5 mm, preferably within a range from about 0.08 to 0.4 mm. A further suitable quartz sand has a particle size for example within a range from about 0.1 to 1 mm, preferably from about 0.2 to 0.8 mm.

A suitable calcium carbonate has for example a mean particle diameter in the region of 2.5 μm and a grading line with absence of residue of about 40 μm. A suitable limestone flour has a fineness for example of <0.1 mm.

In the text below, weight figures based on the screed composition are based on the dry weight of the screed composition, unless otherwise indicated.

The total amount of aluminate binder and calcium sulfate binder in the screed composition is 20% to 70% by weight, preferably 24% to 55% by weight, more preferably 24% to 35% by weight.

The weight ratio of aluminate binder to calcium sulfate binder in the screed composition is in the range from 1:1 to 1:5, preferably in the range from 1:1.6 to 1:4, more preferably 1:2 to 1:3.5. The weight ratio of aluminate binder to calcium sulfate binder is very preferably in the range from 1:2.1 to 1:3.

The amount of filler in the screed composition is 30% to 80% by weight, preferably 35% to 75% by weight.

In one preferred embodiment, the screed composition comprises:
i) 5% to 15% by weight of the aluminate binder,
ii) 15% to 40% by weight, preferably 15% to 30% by weight, of the calcium sulfate binder, and
iii) 50% to 75% by weight of the one or more fillers.

As well as the fillers, the screed composition may further comprise one or, preferably, two or more further additives.

In one preferred embodiment, the screed composition further comprises at least one polyol having a functionality of 4 or less and an OH group density of at least 0.033 mol OH per g polyol. A polyol has at least 2 hydroxyl groups. The at least one polyol is preferably glycerol and/or erythritol, preferably erythritol. Preferably only one such polyol is used.

It is known that compositions based on binary or ternary binders are also subject commonly to shrinkage during the setting and drying process. Such shrinkage is deleterious to the functionality, as it may, for example, frequently be the cause of cracks forming or of screeds bulging. It has emerged that the use of at least one aforesaid polyol results in a particularly large reduction in shrinkage.

The at least one polyol, preferably glycerol and/or erythritol, is present preferably in an amount of 0.5% to 10% by weight, more preferably 1.2% to 6.5% by weight, based on the weight of the aluminate binder. It has been found that the reduction in shrinkage is particularly pronounced at such polyol dosage levels.

In one preferred embodiment, the screed composition further comprises at least one lithium salt, which accelerates the curing of the composition. Suitable lithium salts are, for example, lithium sulfate and lithium halides, especially lithium chloride, and also lithium carbonate. The most preferred is lithium carbonate.

The lithium salt, especially lithium carbonate or lithium sulfate, is present preferably in an amount of 0.001% to 0.5% by weight, more preferably 0.005% to 0.05% by weight, in the screed composition. At less than 0.001%, the concentration is generally too low to produce any notably accelerating effect, whereas an addition of more than 0.5% by weight may lead to excessively rapid curing of the composition.

In one preferred embodiment, the screed composition further comprises tartaric acid and/or a tartaric acid salt, preferably an alkali metal salt of tartaric acid, preferably in an amount of 0.15% to 0.005% by weight, more preferably 0.1% to 0.01% by weight, very preferably 0.08% to 0.015% by weight. Preference is given to sodium or potassium tartrate or to the mixed salt sodium/potassium tartrate.

The addition of tartaric acid and/or a tartaric acid salt has benefits for the expansion characteristics of the screed composition, enabling excessive expansion of the material to be suppressed. To achieve such an effect, at least 0.005% by weight is generally used, while more than 0.15% by weight can lead to severe retardation of setting.

In one particularly preferred embodiment, the screed composition comprises all of the additives stated above. The screed composition may additionally comprise further customary additional additives, examples being plasticizers, thickeners, dyes and/or color pigments, defoamers, stabilizers, curing retarders and/or flexibilizers. The overall concentration of such additional additives is usefully in the range of about 0.1% and 10% by weight, preferably about 0.5% and 5% by weight, more preferably about 1% and 3% by weight.

Examples of suitable color pigments are iron oxides. Examples of suitable flexibilizers are organic polymers, based for example on vinyl acetate and ethylene, which are available, for example, as Vinnapas® 5025 L from Wacker. Suitable stabilizers are, for example, hydroxyethylcelluloses, which are available, for example, as Tylosel® H 20 P2 from ShinEtsu SE Tylose GmbH & Co. KG. Suitable thickeners are, for example, methylcelluloses, which are sold for example under the trade name Culminal®. Moreover, it may be useful to add a “superplasticizer”, e.g., a polycarboxylate ether (PCE). A suitable retarder is available for example under the trade name Retardan® P from Sika Schweiz AG. Further suitable retarders are sodium gluconate, or sodium citrate. One suitable defoamer is, for example, Foamstar® PB1922 from BASF.

The screed composition may further comprise Portland cement; this, however, is generally not preferred. The screed composition may comprise, for example, up to 5% by weight of Portland cement, preferably not more than 3% by weight, more preferably not more than 1% by weight, more particularly not more than about 0.1% by weight. Preferably, however, the screed composition is free from Portland cement. The screed composition is also preferably free from other activators, especially calcium hydroxide, sodium hydroxide, potassium hydroxide, alkali metal silicates, and mixtures thereof. Such activators, especially Portland cement, act as bases and influence the pH.

The amounts of the individual constituents in the screed composition may also be dependent on the mode of application and the layer thickness applied. Preferred embodiments as follows may be given in this regard; for these embodiments, in particular, the above-recited weight ratios of aluminate binder to calcium sulfate binder are also valid:
for a screed layer thickness of 3 mm or more, especially 20 mm or more or 60 mm or more, preferably 3 to 100 mm, e.g., 10 to 75 mm, the total amount of aluminate binder and calcium sulfate binder in the screed composition is preferably in the range from about 20% to 45% by weight, more particularly about 24% to
39% by weight, and the amount of one or more fillers is about 50% to 80% by weight, preferably about 55% to 75% by weight.
for a thin bed of the screed with a layer thickness of less than 10 mm, e.g., in the range from 3 to 6 mm, the total amount of aluminate binder and calcium sulfate binder in the screed composition is preferably in the range from 45% to
70% by weight, preferably 50% to 60% by weight, and the amount of one or more fillers is in the range from about 30% to 50% by weight, preferably
20 40% to 45% by weight.

One advantageous embodiment of the screed composition of the invention comprises
5% to 20% by weight of aluminate binder,
15% to 50% by weight of calcium sulfate hemihydrate,
5% to 12% by weight of calcium carbonate as filler,
30% to 70% by weight of quartz sand,
0.01% to 0.10% by weight of potassium sodium tartrate,
0.005% to 0.5% by weight of lithium salt, especially lithium carbonate or lithium sulfate.

In particular, the screed compositions of the present invention are dry compositions. The water content of screed compositions of the present invention is commonly less than 3% by weight, preferably less than 2% by weight, more preferably less than 1% by weight, based in each case on the total mass of the screed composition. Dry screed compositions of this kind have an improved storage stability.

In step a) of a method of the invention, the screed composition is mixed with water, commonly on site, to give a screeding compound, which is also referred to as screed mortar. The fresh screeding compounds may be fluid or pasty.

In one embodiment, the screeding compound may be self-leveling, i.e., the screed composition is/forms a floating screed. In one preferred embodiment, the screed composition is/forms a sloping screed, meaning that the screed itself or the surface it forms may be provided with an incline. This is an advantage especially in wet rooms, such as bathrooms, for example. The screed composition is with further preference a bonded screed, meaning that it is firmly bonded to the underlying substrate. Sloping screeds are, in particular, bonded screeds.

Since the screed composition contains hydraulic binders in the form of aluminate binder and calcium sulfate binder, hydration reactions take place, as is known, on addition of water. The screeding compound cures over time by drying/setting. Further processing must of course take place prior to curing, when the screeding compound is still fluid or pasty.

The consistency or rheological behavior of the screeding compound may be adjusted not only through the choice of additives used but also, in particular, through the mixing ratio of screed composition to water. It is preferred to mix the screed composition with water in a mass ratio of water to screed composition of 0.08 to 0.40, preferably 0.10 to 0.30, more particularly 0.11 to 0.20, so as to obtain a fluid or pasty screeding compound. The screeding compound is preferably pumpable, so facilitating transport.

It has emerged that for different mixing ratios of screed composition and water, the screed develops relatively constant construction-related physical properties, and strengths as well. Thus it is possible, for example, to set different screeding compound consistencies and yet obtain uniform construction-related physical properties and/or strengths. This provides the user with particular flexibility.

The method of the invention comprises a step b) of applying the screeding compound to the substrate. The mode of application may of course depend on the consistency of the screeding compound. Application may be made using any of the means known to the person skilled in the art, as for example via trowel, brush or roller, by pouring, or via injection or spraying methods. The screeding compound may be applied completely in one step or may be applied in two or more successive steps, in several layers one above the other. Application in several layers allows a greater overall layer thickness to be achieved.

There are no restrictions on the substrate to which the screed composition is applied. It is preferable for the screed after drying to attach firmly to the substrate, i.e., to form a bonding screed.

Examples of suitable substrates are substrates of concrete, floorcoverings, such as wooden floorboards, fixed parquet, chipboard panels, wood-cement boards, existing substrates with ceramic coverings, existing substrates based on screeds, or concrete. The substrate is preferably a concrete substrate.

The substrate may optionally be provided with a primer coat prior to the application of the screeding compound. The primer is in this case applied to the substrate. Pretreatment of this kind is known to the person skilled in the art.

Following application of the screeding compound, the screeding compound can be dried in step c) of a method of the invention. This drying generally takes place under the existing ambient conditions. Drying may optionally be assisted by increased air circulation, e.g., drafts, or elevated temperatures. The screeding compound may be dried at various temperatures, e.g., in the range from 4° C. to 50° C., preferably 5° C. to 35° C.

Drying results in a dried screed which undergoes increasing setting or curing over time. The drying duration to give a dried screed suitable for further processing is dependent on factors including the constitution of the screed composition and the ambient conditions. A dried screed amenable to further processing is generally referred to as a covering-ready screed. Important parameters for this are the strength achieved and residual moisture content of the screed.

A particular advantage of the method of the invention is that further processing is enabled, or covering-readiness achieved, after just a relatively short drying duration. In particular, sufficient adhesion between screed and seal can be obtained even on early application of the seal.

In one preferred embodiment, the drying duration of the screeding compound in step c) until ready for covering or until the seal is applied is not more than 24 hours, preferably less than 10 hours, more preferably in the range from 3 to 8 hours, very preferably 4 to 6 hours.

In step d) of the method of the invention, after the drying in step c), a seal is applied to the dried screed. The seal represents a barrier which prevents penetration of water or moisture into the underlying parts of the floor construction. It is therefore a waterproof seal. The waterproof seal may be formed by adhered membranes in sheet form or plate form, or by sealants that are applied in fluid or pasty form and solidify. In both cases, the seal is adhesively bonded in particular to the underlying screed. Suitable systems are described for example in particular in DIN EN 14891.

The dried screed may optionally be provided with a primer coat prior to the application of the seal.

In one variant, a seal is applied in step dl) by adhering a sheetlike or platelike membrane to the dried screed by means of an adhesive. The sheetlike or platelike membrane is preferably in the form of a sheet, which is available as a roll product, for example. It will be appreciated that in the case of extensive areas, generally a plurality of sheets or plates of the membrane are adhered next to one another.

The sheetlike or platelike membrane may comprise a single-layer or multilayer film. The sheetlike or platelike membrane preferably comprises a single-layer or multilayer plastic film. Such membranes are also referred to as sheetlike or platelike plastic membranes.

The sheetlike or platelike membrane may comprise, for example, a single-layer or multilayer plastic film, more particularly a thermoplastic film, in which case it is preferably a polyethylene film. This results in high resistance to environmental effects. The plastic film may also be referred to as a plastics layer. The plastic film is also referred to in particular as a bulkhead layer. Its effect in particular is to render the membrane impervious to water.

The plastic film is preferably formed of high-density polyethylene (HDPE), medium-density polyethylene (MDPE), low-density polyethylene (LDPE), polyethylene (PE), polyethylene terephthalate (PET), polystyrene (PS), polyvinyl chloride (PVC), polyamides (PA), ethylene-vinyl acetate (EVA), chlorosulfonated polyethylene, thermoplastic polyolefins (TPO), ethylene-propylene-diene rubber (EPDM), and mixtures thereof.

These plastic films, plastics layers or bulkhead layers may for example have a thickness of 0.1 — 5 mm, more particularly 0.3-2.5 mm, preferably 0.4-1.5 mm.

Besides the single-layer or multilayer plastic film (bulkhead layer), the sheetlike or platelike membrane may further comprise one or more sheetlike textile elements as well, such as a woven fabric, scrim fabric, knitted fabric or nonwoven fabric, which serve for reinforcement and/or for better incorporation into the floor construction. Such sheetlike textile elements are also referred to as an integration layer. The sheetlike textile element is formed of fibers, which may be made of organic or synthetic material. The fibers in question are cellulose, cotton or protein fibers or are synthetic fibers, such as fibers of polyester or of a homopolymer or copolymer of ethylene and/or propylene, or of viscose.

In one preferred embodiment, the sheetlike or platelike membrane comprises at least one plastic film (bulkhead layer) and at least one sheetlike textile element (integration layer). In one preferred embodiment, the membrane comprises a polyethylene film lined on either side with nonwoven, with a thickness of about 0.5 mm.

Examples of suitable sheetlike or platelike membranes include sealing sheets based on a nonwoven or knitted carrier bearing a bulkhead layer applied over the full area or in stripes. Variants include sealing sheets where a bulkhead layer is sited between two sheetlike textile elements, such as nonwoven carriers, for example, or in which a sheetlike textile element is on one side of the bulkhead layer, and a self-adhesive component on the other side.

The sheetlike or platelike membrane is applied to the dried screed by means of an adhesive, producing the bond between screed and membrane. The adhesive is generally applied to the dried screed, by means of rollers, for example. The sheetlike or platelike membrane is subsequently laid onto the adhesive. It is also possible to use sheetlike or platelike membranes which comprise an adhesive layer and can be adhered directly over the screed.

Adhesives used may be customary adhesives known to the person skilled in the art. Examples of suitable adhesives include polymer dispersions, especially acrylic polymer dispersions, powder-based dispersions, such as powder-based polymer dispersions, especially powder-based acrylate dispersions, polyurethane adhesives or tile adhesives. The adhesive may be a one-component or multicomponent adhesive, such as a two-component adhesive, for example. The adhesive is preferably an aqueous dispersion-based adhesive.

Suitable adhesives are, for example, acrylic polymer dispersion-based adhesives, polyurethane dispersion-based adhesives, or dispersion-based adhesives containing polyurethane and a copolymer of ethylene, vinyl acetate and optionally (meth)acrylate.

The tile adhesive may be cementitious or polymer-bound (cement-based or dispersion-based adhesive). Suitable tile adhesives are indicated for example as in standard DIN EN 12004.

One example of a commercially available membrane for sealing is Schönox® AB from Sika Schweiz AG. This is a polyethylene film with double-sided nonwoven lining, with a thickness of about 0.5 mm. A further example of a membrane is Schönox® WSF. Examples of suitable adhesives include Schönox iFix® from Sika Schweiz AG, a self-crosslinking, acrylate-based dispersion based on powder, or Schönox® HA from Sika Schweiz AG, a polymer dispersion.

In a second variant, a seal is applied in step d2) by applying a fluid or pasty sealing material to the dried screed. The fluid or pasty sealing material to be applied is commonly also referred to as a liquid-applied seal.

After application, the sealing material solidifies and forms a seal. Solidification may take place by a drying process and/or a curing process. Curing may take place by hydration reactions of a hydraulic binder and/or crosslinking reactions of polymeric compounds. The sealing material may be a one-component or multicomponent sealing material, such as a two-component sealing material, for example. In the case of multicomponent sealing materials, the components are mixed with one another before application.

The sealing material is preferably selected from a polymer dispersion, a slurried sealant or a reactive resin, preference being given to polymer dispersions, e.g., acrylate-based dispersions, and slurried sealants. Slurried sealants are also referred to as slurry-type seal coatings.

The sealing material, more particularly the slurried sealant, may comprise hydraulic binder, for example. In one preferred embodiment, the sealing material, more particularly the slurried sealant, comprises at least one hydraulic binder and at least one synthetic polymer. Examples of suitable hydraulic binders are Portland cement, aluminate cement, calcium sulfoaluminate cement, calcium sulfate (anhydrite or hemihydrate), natural hydraulic lime, slag, pozzolans, and mixtures thereof. Examples of suitable synthetic polymers are polymers or copolymers of vinyl acetate, ethylene, acrylate, styrene and butadiene, or polyurethanes, and mixtures thereof.

The sealing material may comprise bitumen, in the form of a bitumen emulsion, for example. An example is a sealing material, more particularly slurried sealant, which comprises hydraulic binder, at least one synthetic polymer, and bitumen, with examples of hydraulic binders and synthetic polymers having been stated above.

Polymer dispersions contain synthetic polymers, examples being those stated above, preferably polymers or copolymers of acrylates. The dispersion may comprise water and/or organic solvents. The polymer dispersion may be self-crosslinking.

Where fluid or pasty sealing materials are used, their application may be preceded by the application to the dried screed of an adhesive, such as one of those described above, in order to achieve better adhesion. In general, however, this is unnecessary.

Examples of suitable fluid or pasty sealing materials include Schönox® 1K DS from Sika Schweiz AG, a cementitious slurried sealant, or Schönox® 2K DS from Sika Schweiz AG, a self-crosslinking, acrylate-based dispersion.

In optional step e), a floorcovering is applied optionally to the seal. Application of a floorcovering is preferred, especially when a sheetlike or platelike membrane is employed for sealing.

The floorcovering is preferably a tiled flooring or slab flooring, which may be adhered to the seal in a usual way. The tiles or slabs are made, for example, of ceramic, glass, textiles, plastics, metals or natural stone. Further suitable coverings include plastic-based coverings, especially PVC coverings or floor tiles made of PVC (LVT, luxury vinyl tiles).

The floor construction obtained by the method of the invention is preferably a floor structure, particularly for the interior sector. The floor structure or construction is suitable, for example, for floors in bathrooms, shower rooms, kitchens, pools, balconies, patios or saunas, but is also suitable for rooms in the non-wet sector.

The screed in the floor construction preferably has a layer thickness in the range from 3 to 100 mm, more preferably 10 to 75 mm.

A particular advantage according to one preferred embodiment is that the drying time of the screed is substantially independent of the layer thickness of the screed, the layer thickness being preferably in the range from 10 to 75 mm.

The technical benefit of higher layer thicknesses of more than 10 mm, for example, preferably more than 20 mm, is in particular that it is possible to develop load-bearing capacity on the part of the floor construction, and/or to adjust the load-bearing capacity to required values by way of the layer thickness.

A drying time for the screed that is substantially independent of the layer thickness of the screed means here in particular that the drying times for a screed for each layer thickness in the range from 3 to 100 mm, preferably for each layer thickness in the range from 10 to 75 mm, differ from one another by not more than 15 min, preferably not more than 5 min, more preferably by not more than 1 min, under otherwise identical conditions.

The drying time here is the time from application of the screeding compound to the substrate until the screed becomes covering-ready. Ready for covering means generally that the screed has dried out to the equilibrium moisture content; in other words, that its water content is in equilibrium with the surrounding room air. The water content or residual moisture content may be determined by the CM method.

The invention further relates to a floor construction comprising a substrate, a screed overlying the substrate, a seal overlying the screed and being an adhered membrane or a sealing material applied in fluid or pasty form and then solidified, and optionally a floorcovering overlying the seal, wherein the screed is formed of a screed composition mixed with water and cured that comprises
i) an aluminate binder selected from calcium aluminate cement and/or calcium sulfoaluminate cement,
ii) a calcium sulfate binder selected from calcium sulfate hemihydrate and/or calcium sulfate anhydrite, and
iii) one or more fillers,

where the amount of filler is 30% to 80% by weight and the total amount of aluminate binder and calcium sulfate binder is 20% to 70% by weight, with the weight ratio of aluminate binder to calcium sulfate binder being in the range from 1:1 to 1:5, the weight figures being based on the dry weight of the screed composition.

All of the indications given above for the method of the invention are equally valid for the floor construction of the invention, especially in relation to screed composition, substrate, screed, seal, sheetlike or platelike membrane, adhesive, sealing material and floorcovering, and so reference is made to said indications.

The floor construction of the invention is preferably obtainable by the method of the invention as described above.

The invention is elucidated in more detail hereinbelow with reference to exemplary embodiments. The examples are provided by way of illustration and are not intended to limit the present invention in any way.

### EXEMPLARY EMBODIMENTS

### Inventive Example 1

A screed composition suitable for the method of the invention was produced from the ingredients indicated in table 1 below. Table 1 also indicates the percentage weight fractions of the ingredients, based on the weight of the screed composition.

TABLE 1
Formulation of screed composition

| | | Fraction |
|---|---|---|
| Component | Function | [wt %] |
| Calcium sulfoaluminate cement | Binder | 7.660 |
| alpha-Calcium sulfate hemihydrate | Binder | 19.940 |
| Chalk (fine particle size) | Filler | 4.500 |
| Limestone flour | Filler | 5.0000 |
| Quartz sand, AFS number L50 | Filler | 24.2100 |
| Calcium sulfate dihydrate | Activator for the | 0.7500 |
| | hemihydrate | |
| Quartz sand 0.5-1.0 mm | Filler | 36.5000 |
| Vinyl acetate-ethylene copolymer | Redispersible powder | 1.0000 |
| Hydroxyethylcellulose | Thickener | 0.0530 |
| Lithium carbonate 99% | Accelerator | 0.0080 |
| Defoamer | Defoamer | 0.0750 |
| Potassium sodium tartrate | Retarder | 0.0370 |
| Sodium gluconate powder | Retarder | 0.0370 |
| Erythritol | Shrinkage reducer | 0.1900 |
| Polycarboxylate ether | Superplasticizer | 0.0300 |
| Starch ether | Thickener | 0.010 |

### Comparative Examples 1 and 2

Screed compositions (dry screeds) suitable for floor constructions with seals for bathrooms are available commercially. The following commercial products are ternary binder systems which are employed in the same thickness range, and have been used for comparison:

| | | |
|---|---|---|
| Comparative | Schönox ® CLS | Sika Schweiz AG |
| example 1 | | |
| Comparative | Centro ® GA#50 Speed | Centro Kakel och Klinker |
| example 2 | | AB, Sweden |

### Example 2

Floor constructions were produced with the screed compositions of inventive example 1 and comparative examples 1 and 2.

The screeding compound was produced by mixing the screed compositions of inventive example 1 and comparative examples 1 and 2 with water. Inventive example 1 was carried out using 3.5 L of water per 25 kg of composition. In accordance with manufacturer indications, for Schönox® CLS 3.5 L of water per 25 kg of composition and for Centro® GA#50 Speed 4.5 L of water per 25 kg of composition were used.

Sealing took place using the plastic membrane Schönox® AB. This is a polyethylene film with double-sided nonwoven lining, with a thickness of about 0.5 mm.

The adhesive used for bonding the seal was a self-crosslinking, acrylate-based dispersion based on powder (Schönox iFix®) or a polymer dispersion (Schönox® HA).

The floor was constructed in principle as follows:
1. The substrate used was a dry concrete slab.
2. The concrete slab was treated with a primer: Schönox® VD primer (mixing ratio, primer to water: 1:3).
3. The screeding compounds produced from the screed compositions of inventive example 1 and comparative examples 1 and 2 were applied to the primed substrate in different layer thicknesses.
4. The applied screeding compound was dried for 4 hours or 24 hours (drying time).
5. After a 4-hour or 24-hour drying time for the screeding compound, the plastic membrane Schönox AB was adhered with an adhesive (Schönox iFix or Schönox HA) to the dried screeding compound.

After different curing durations (e.g., after 3 days or 7 days), tensile adhesive strengths were determined on the resulting floor constructions. Storage conditions: 20° C., 55% relative humidity (standard conditions). The results are reported in tables 2 to 4.

The tensile adhesive strength was performed in accordance with DIN EN 13892-8.

Tables 2a and 2b show adhesive strengths after 3-day curing for the screed composition used from inventive example 1 and the comparative examples for a drying time of 4 hours (table 2a) or 1 day (table 2b) before membrane application, screed layer thickness: 50 mm, adhesive: Schönox HA, seal: Schönox AB.

TABLE 2a
Drying time: 4 h, thickness 50 mm, curing: 3 days

| | Adhesive | |
|---|---|---|
| | strength | |
| Screed composition | [N/mm²] | Fracture |
| Inventive example 1 | 0.46 | between screed and adhesive |
| Comparative example 1 | 0.16 | between screed and adhesive |
| Comparative example 2 | — | adhesive has detached |

TABLE 2b
Drying time: 1 day, thickness 50 mm, curing: 3 days

| | Adhesive | |
|---|---|---|
| | strength | |
| Screed composition | [N/mm²] | Fracture |
| Inventive example 1 | 0.47 | between screed and adhesive |
| Comparative example 1 | 0.23 | between screed and adhesive |
| Comparative example 2 | — | adhesive has detached |

Tables 3a and 3b show adhesive strengths after 7-day curing for the screed composition used from inventive example 1 and the comparative examples for a drying time of 4 hours (table 3a) or 1 day (table 3b) before membrane application, screed layer thickness: 50 mm, adhesive: Schönox HA, seal: Schönox AB.

TABLE 3a
Drying time: 4 h, thickness 50 mm, curing: 7 days

| | Adhesive | |
|---|---|---|
| | strength | |
| Screed composition | [N/mm²] | Fracture |
| Inventive example 1 | 0.60 | between screed and adhesive |
| Comparative example 1 | 0.22 | between screed and adhesive |
| Comparative example 2 | 0.08 | between screed and adhesive |

TABLE 3b
Drying time: 1 day, thickness 50 mm, curing: 7 days

| | Adhesive | |
|---|---|---|
| | strength | |
| Screed composition | [N/mm²] | Fracture |
| Inventive example 1 | 0.89 | between screed and adhesive |
| Comparative example 1 | 0.30 | between screed and adhesive |
| Comparative example 2 | 0.39 | between screed and adhesive |

Table 4 shows adhesive strengths after 3 days for the screed composition from inventive example 1 for a drying time of 4 hours, screed layer thickness: 13 mm, adhesive: Schönox iFix.

TABLE 4
Drying time: 4 h, thickness 13 mm, curing: 3 days

| | Adhesive strength | |
|---|---|---|
| Screed composition | [N/mm²] | Fracture |
| Inventive example 1 | 0.54 | between adhesive and |
| | | membrane |

The results in table 2a/2b and table 3a/3b show that the floor construction of the invention exhibits distinct advantages in the tensile adhesive strengths after 4 hours and 24 hours of curing time of the screed composition from inventive example 1 in comparison to comparative examples 1 and 2. Comparative example 2 does not achieve any strength values after three days of tensile adhesive testing for drying times of 4 h and 24 h. All of the strength values rise over longer curing times, from the third to the seventh day after application of the membrane, for example. Table 4 shows good values for the adhesion when using the powder adhesive to bond the sheet membrane as well. The strength values of the built construction of the invention are more or less independent of the layer thickness.

### Example 3

Furthermore, the drying behavior of the screeding compounds obtained from the screed compositions of inventive example 1 and comparative examples 1 and 2 was tested.

This was done by determining the residual moisture content of the screeds by the CM method with Calcium carbide Measuring instrument.

Table 5 shows the results for the screeds, for different layer thicknesses and different curing durations, on storage at room temperature and about 75% atmospheric humidity.

TABLE 5

| | | | | Residual moisture content [CM %] | | |
|---|---|---|---|---|---|---|
| Layer | | | | Comparative | Inventive | Comparative |
| thickness | | Curing duration | | example 1 | example 1 | example 2 |
| 10 | mm | 4 | h | 7.00 | 6.70 | 6.00 |
| 10 | mm | 1 | d | 5.29 | 4.90 | 4.69 |
| 10 | mm | 3 | d | 3.59 | 3.09 | 3.16 |
| 20 | mm | 3 | d | 4.90 | 4.00 | 3.90 |
| 30 | mm | 7 | d | 3.50 | 3.50 | 3.60 |
| 50 | mm | 7 | d | 4.69 | 4.19 | 4.60 |

Table 6 shows the results for the screeds, for different layer thicknesses and different curing durations, on storage at 5° C.

TABLE 6

| | | Residual moisture content [CM %] | | |
|---|---|---|---|---|
| Layer | | Comparative | Inventive | Comparative |
| thickness | Curing duration | example 1 | example 1 | example 2 |
| 10 mm | 1 d | 5.00 | 4.69 | 4.90 |
| 10 mm | 3 d | 3.19 | 2.59 | 3.40 |
| 20 mm | 3 d | 4.29 | 3.69 | 4.10 |

Table 5 shows the faster drying properties of inventive example 1 used, in comparison to the comparative examples. Comparison of table 5 with table 6 reveals that the drying properties of the inventive example are more or less independent of the temperature, especially in comparison to comparative example 2.

### Example 4

Using the screed compositions of inventive example 1 and comparative examples 1 and 2, compressive strengths and flexural tensile strength were measured according to standard EN 1015-11:1999+A1:2006 on prisms with dimensions of 40×40×160 mm after the times indicated in table 7. The screeding compound was produced by mixing the screed compositions of inventive example 1 and comparative examples 1 and 2 with water. For inventive example 1, in one instance 3.5 L of water per 25 kg of composition were used, and in another instance 2.9 L of water per 25 kg of composition were used. In accordance with manufacturer indications, for Schönox® CLS 3.5 L of water per 25 kg of composition and for Centro® GA#50 Speed 4.5 L of water per 25 kg of composition were used.

Table 7 below shows the results of the measurements.

TABLE 7

| | | Centro ® | | |
|---|---|---|---|---|
| | Schönox ® | GA#50 | Inventive | Inventive |
| | CLS | Speed | example 1 | example 1 |
| Water per 25 kg of | 3.5 | 4.5 | 3.5 | 2.9 |
| powder [liters] | | | | |
| Compressive | n.m. | n.m. | 6.3 | 8.0 |
| strength, 4 h [MPa] | | | | |
| Compressive | 31.3 | 34.2 | 36.2 | 42.6 |
| strength, 28 d [MPa] | | | | |
| Flexural tensile | n.m. | n.m. | 1.7 | 2.2 |
| strength, 4 h [MPa] | | | | |
| Flexural tensile | 7.6 | 8.1 | 8.7 | 10.4 |
| strength, 28 d [MPa] | | | | |

n.m.: not measurable

Table 7 shows the best compressive strengths and flexural tensile strengths on inventive example 1 both after a short curing time of 4 h and after a longer curing time of 28 d. This is the case for both tested proportions of water to screed composition.

1. A method for producing a floor construction on a substrate, comprising the following steps:
a) mixing a screed composition with water to form a screeding compound,
b) applying the screeding compound to the substrate,
c) drying the screeding compound to form a dried screed, and
d) applying a seal to the dried screed by
d1) adhering a sheetlike or platelike membrane to the dried screed using an adhesive or
d2) applying a fluid or pasty sealing material to the dried screed, with the sealing material solidifying to form the seal, and
e) optionally applying a floorcovering to the seal, where the screed composition comprises
i) an aluminate binder selected from calcium aluminate cement and/or calcium sulfoaluminate cement,
ii) a calcium sulfate binder selected from calcium sulfate hemihydrate and/or calcium sulfate anhydrite, and
iii) one or more fillers,
where the amount of filler is 30% to 80% by weight and the total amount of aluminate binder and calcium sulfate binder is 20% to 70% by weight, with the weight ratio of aluminate binder to calcium sulfate binder being in the range from 1:1 to 1:5, the weight figures being based on the dry weight of the screed composition.

2. The method as claimed in claim 1, wherein the weight ratio of aluminate binder to calcium sulfate binder is in the range from 1:1.6 to 1:4.

3. The method as claimed in claim 1, wherein
the amount of filler is 35% to 75% by weight and/or
the total amount of aluminate binder and calcium sulfate binder is 20% to 60% by weight.

4. The method as claimed in claim 1, wherein the screed composition comprises:
i) 5% to 15% by weight of the aluminate binder,
ii) 15% to 40% by weight of the calcium sulfate binder, and
iii) 50% to 75% by weight of the one or more fillers.

5. The method as claimed in claim 1, wherein the screed composition further comprises at least one polyol having a functionality of 4 or less and an OH group density of at least 0.033 mol OH per g polyol.

6. The method as claimed in claim 5, wherein
the one or more fillers comprise sand and/or calcium carbonate and/or
the at least one polyol is glycerol and/or erythritol.

7. The method as claimed in claim 1,
wherein the screed composition further comprises at least one lithium salt, and/or
wherein the screed composition further comprises tartaric acid and/or a tartaric acid salt.

8. The method as claimed in claim 1, wherein the substrate is a concrete substrate.

9. The method as claimed in claim 1, wherein the screed has a layer thickness in the range from 3 to 100 mm.

10. The method as claimed in claim 1, wherein the drying time of the screed is substantially independent of the layer thickness of the screed.

11. The method as claimed in claim 1, wherein the drying duration of the screeding compound in step c) until ready for covering is not more than 24 hours.

12. The method as claimed in claim 1, wherein
the sheetlike or platelike membrane comprises a single-layer or multilayer plastic film and/or
wherein the adhesive is a polymer dispersion or a powder-based dispersion or a tile adhesive, or
the fluid or pasty sealing material is selected from a polymer dispersion, a slurried sealant or a reactive resin.

13. The method as claimed in claim 1, wherein the floorcovering is a tiled flooring, a slab flooring or a plastic-based flooring.

14. A floor construction comprising a substrate, a screed overlying the substrate, a seal overlying the screed and being an adhered sheetlike or platelike membrane or a sealing material applied in fluid or pasty form and then solidified, and optionally a floorcovering overlying the seal, wherein the screed is formed of a screed composition mixed with water and cured that comprises
i) an aluminate binder selected from calcium aluminate cement and/or calcium sulfoaluminate cement,
ii) a calcium sulfate binder selected from calcium sulfate hemihydrate and/or calcium sulfate anhydrite, and
iii) one or more fillers,
where the amount of filler is 30% to 80% by weight and the total amount of aluminate binder and calcium sulfate binder is 20% to 70% by weight, with the weight ratio of aluminate binder to calcium sulfate binder being in the range from 1:1 to 1:5, the weight figures being based on the dry weight of the screed composition.

15. The floor construction as claimed in claim 14, wherein
the weight ratio of aluminate binder to calcium sulfate binder is in the range from 1:1.6 to 1:4.

16. The floor construction as claimed in claim 14, obtainable by a method comprising the following steps:
a) mixing the screed composition with water to form the screeding compound,
b) applying the screeding compound to the substrate,
c) drying the screeding compound to form the dried screed, and
d) applying the seal to the dried screed by
d1) adhering the sheetlike or platelike membrane to the dried screed using an adhesive or
d2) applying the fluid or pasty sealing material to the dried screed, with the sealing material solidifying to form the seal, and
e) optionally applying the floorcovering to the seal, where the screed composition comprises
i) the aluminate binder selected from calcium aluminate cement and/or calcium sulfoaluminate cement,
ii) the calcium sulfate binder selected from calcium sulfate hemihydrate and/or calcium sulfate anhydrite, and
iii) one or more fillers,
where the amount of filler is 30% to 80% by weight and the total amount of aluminate binder and calcium sulfate binder is 20% to 70% by weight, with the weight ratio of aluminate binder to calcium sulfate binder being in the range from 1:1 to 1:5, the weight figures being based on the dry weight of the screed composition.
